(19) United States
(12) Patent Application Publication
(10) Pub. No.: US 2011/0183253 A1
(43) Pub. Date: Jul. 28, 2011

(54) CORE MATERIAL OF FERRITE CARRIER AND FERRITE CARRIER FOR ELECTROPHOTOGRAPHIC DEVELOPER, AND ELECTROPHOTOGRAPHIC DEVELOPER USING THE FERRITE CARRIER

(75) Inventors: Koji AGA, Kashiwa-shi (JP); Toru IWATA, Kashiwa-shi (JP)

(73) Assignee: POWDERTECH CO., LTD., Chiba (JP)

(21) Appl. No.: 12/962,833

(22) Filed: Dec. 8, 2010

(30) Foreign Application Priority Data
Jan. 28, 2010 (JP) 2010-016898

(51) Int. Cl. G03G 9/107

(52) U.S. Cl. 430/111.33; 430/111.31

(57) ABSTRACT

A core material of a ferrite carrier for an electrophotographic developer, the core material being composed of a ferrite particle containing at least one or more temperature compensation-type dielectric components selected from Mg₂TiO₄, MgTiO₃ and MgTi₂O₄, a ferrite carrier for an electrophotographic developer, the ferrite carrier being prepared by coating a surface of the carrier core material with a resin, and an electrophotographic developer using the ferrite carrier.

### BACKGROUND OF THE INVENTION

1. Field of the Invention

The present invention relates to a core material of a ferrite carrier and a ferrite carrier for an electrophotographic developer used for a two-component electrophotographic developer used in copying machines, printers and the like, and an electrophotographic developer using the ferrite carrier.

2. Description of the Related Art

The method of electrophotographic development is a method in which toner particles in a developer are made to carry over on electrostatic latent images formed on a photoreceptor to develop the images. The developer used in this method is classified into a two-component developer composed of a toner particle and a carrier particle, and a one-component developer using a toner particle alone.

As a development method using a two-component developer composed of a toner particle and a carrier particle among those developers, a cascade method and the like were formerly employed, but a magnetic brush method using a magnet roll is now in the mainstream.

In a two-component developer, a carrier particle is a carrier substance which is stirred with a toner particle in a development box filled with the developer to thereby impart a desired charge to the toner particle, and further transports the charged toner particle to a surface of a photoreceptor to thereby form a toner image on the photoreceptor. The carrier particle remaining on a development roll to hold a magnet is again returned from the development roll to the development box, mixed and stirred with a fresh toner particle, and used repeatedly in a certain period.

In a two-component developer, unlike a one-component developer, a carrier particle has functions of being mixed and stirred with a toner particle to charge the toner particle and transporting the toner particle, and has good controllability on designing a developer. Therefore, the two-component developer is suitable for full-color development apparatuses requiring a high image quality, high-speed printing apparatuses requiring reliability and durability in image maintenance, and other apparatuses.

In a two-component developer thus used, it is needed that image characteristics, such as image density, fogging, white spots, gradation and resolving power, exhibit predetermined values from the initial stage, and additionally these characteristics do not vary and are stably maintained during endurance printing. In order to stably maintain these characteristics, characteristics of a carrier particle contained in a two-component developer need to be stable.

As a carrier particle forming a two-component developer, an iron powder carrier, such as an iron powder whose surface is covered with an oxide film or an iron powder coated whose surface is coated with a resin, has conventionally been used. Since such an iron powder carrier has a high magnetization and also a high conductivity, it has an advantage of easily providing images good in the reproducibility of solid portions.

However, since such an iron powder carrier has a true specific gravity as heavy as about 7.8 and a too high magnetization, stirring and mixing thereof with a toner particle in a development box is liable to generate fusing of toner-constituting components on the iron powder carrier surface, so-called toner spent. Such generation of toner spent reduces an effective carrier surface area, and is liable to decrease the frictional chargeability of a toner particle.

In a resin-coated iron powder carrier, a resin on the surface is peeled off due to stress during the durable period and a core material (iron powder) having a high conductivity and a low dielectric breakdown voltage is exposed, thereby causing the leakage of the charge in some cases. Such leakage of the charge causes the breakage of electrostatic latent images formed on a photoreceptor and the generation of brush streaks on solid portions, thus hardly providing uniform images. For these reasons, iron powder carriers such as an oxide film-coated iron powder and a resin-coated iron powder have come not to be used recently.

Recently, in place of the iron powder carrier, a ferrite having a true specific gravity as light as about 5.0 and also a low magnetization has been used as a carrier, and further a resin-coated ferrite carrier having a surface coated with a resin has often been used, whereby the developer life has been remarkably prolonged.

A method for manufacturing such a ferrite carrier generally involves mixing ferrite carrier raw materials in predetermined amounts, thereafter calcining and pulverizing the mixture, and granulating and thereafter sintering the resultant. The calcination may be omitted in some cases, depending on the condition.

In such a ferrite carrier, the magnetization and the resistivity are important characteristics, and a balance between the magnetization and the resistivity is needed.

In order to have a balance between the magnetization and the resistivity, a ferrite carrier using a heavy metal such as Cu, Zn or Ni, or Mn has been used.

Recently, the environmental control has been made strict and the use of heavy metals such as Ni, Cu and Zn comes to be avoided, so the use of a metal in conformity to the environmental control is required. Therefore, the ferrite compositions used as a carrier core material shift from Cu—Zn ferrite and Ni-Zn ferrite to manganese ferrite, Mn—Mg—Sr ferrite and the like, which are ferrites containing much Mn.

Japanese Patent Laid-Open No. 2009-180941 describes a carrier core material for an electrophotographic developer, which contains Mg, Ti and Fe as main components, and contains 52 to 66% by weight of Fe, 3 to 12% by weight of Mg, and 0.2 to 12% by weight of Ti. Japanese Patent Laid-Open No. 2009-180941 contends that the carrier core material provides a low magnetization and, nevertheless, a desired resistivity, and has a coercive force in a degree of not affecting the fluidity, and a good fluidity without using heavy metals or Mn.

In the case where a polyester-based polymerized toner is used in order to achieve a low-temperature fixation involved in the recent year's power saving, since the tone itself is hardly chargeable, it is the real situation that the chargeability of the carrier urgently needs to be raised.

Although the charge level is generally controlled by resin coating, when the charge amount of a carrier core material is small, the resin coating of the carrier surface is gradually peeled off along with the repeated use of the carrier, and the chargeability of the carrier comes to be lost.

In such a situation, although the resin coating of carriers has conventionally been variously improved in the chargeability by types of the resin, additives and the like, the improvements are insufficient from the viewpoint of securing the chargeability because the resin coating is peeled off along with use of the carrier as described above, thus needing a fundamental improvement.

The peeling-off of the resin used for coating causes the occurrence of fogging. Further under the high-temperature high-humidity (H/H) environment, the chargeability is likely to remarkably decrease.

Therefore, a carrier itself is required to have a high charge amount, and additionally in an electrophotographic developer, have a good initial rate of charge, and a charge stability excellent under every environment.

On the other hand, an attempt is made in which specification of a condition regarding dielectric properties, particularly the relaxation time, of a carrier provides a good carrier and exhibits good developer characteristics. Japanese Patent Laid-Open No. 2000-284523 describes a carrier which is a resin-coated carrier obtained by coating the surface of a magnetic particle core material with a resin, and in which the value of the time constant τ (=RC) determined from a semicircular Cole-Cole plot in the impedance measurement obtained from the frequency dependency measured at a sinusoidal alternating voltage is 1×10⁻³ or less. Japanese Patent Laid-Open No. 2000-284523 contends that the carrier can stably provide good images having a high quality and no abnormal images even in a high alternating electric field condition, and exhibits a stable frictional charge because peeling-off of the carrier-coating layer does not occur even during continuous use, and can provide images having as high a fidelity as early images.

Japanese Patent Laid-Open No. 2000-284523 prevents occurrence of carrier beads carry over and the like by specifying the condition regarding the relaxation time of the carrier, but does not intend to pay attention to the dielectric properties of a carrier core material, impart a high charge amount to the carrier, and provide an electrophotographic developer excellent in the charge stability under every environment.

On the other hand, Japanese Patent Laid-Open No. 2007-102052 discloses that, in a magnetic carrier particle obtained by coating the surface of a magnetic carrier core particle containing at least a binder resin, a magnetic particle and a high-dielectric compound with a coating material, the high-dielectric compound has a relative dielectric constant ε of 80 or higher. Japanese Patent Laid-Open No. 2007-102052 contends that images of a stable image density can be output over a long period even in printing in a low-consumption amount.

However, since the magnetic carrier particle described in Japanese Patent Laid-Open No. 2007-102052 is a magnetic powder dispersion-type carrier in which a binder resin coats magnetic microparticles, the carrier resistivity is high. Therefore, there is a problem that a sufficient image density can hardly be obtained.

Supposedly since the magnetic powder dispersion-type carrier is one obtained by hardening magnetic microparticles with a binder resin, and the magnetic microparticles sometimes fall off by stirring stresses and impacts in a development machine, and the magnetic powder dispersion-type carrier is inferior in mechanical strength to iron powder carriers and ferrite carriers, which are conventionally used, there arises a problem that the carrier particles themselves sometimes break. Then, magnetic microparticles having fallen off and broken carrier particles are carried over on a photoreceptor, causing image defects in some cases.

The high chargeability of the carrier can be achieved by adding SrTiO₃, BaTiO₃ and the like as high-dielectric substances to the carrier to make these contained in the carrier, but since these high-dielectric substances have a very high temperature coefficient, only making these substances contained in the carrier cannot improve the environmental dependency of the charge level.

Moreover, Japanese Patent Laid-Open No. 2007-102052 does not intend to impart a high charge amount to the carrier, and provide an electrophotographic developer excellent in the charge stability under every environment.

### SUMMARY OF THE INVENTION

Therefore, it is an object of the present invention to provide a core material of a ferrite carrier for an electrophotographic developer which has a high charge amount, and is also excellent in the charge stability under every environment when the core material is made into an electrophotographic developer, a ferrite carrier obtained by coating a surface of the core material of a ferrite carrier with a resin, and an electrophotographic developer using the ferrite carrier.

As a result of exhaustive studies to solve the above-mentioned problems, the present inventors have found that the use of a core material of a ferrite carrier for an electrophotographic developer containing a temperature compensation-type dielectric component can solve the above-mentioned problem. This finding has led to the present invention.

That is, the present invention provides a core material of a ferrite carrier for an electrophotographic developer, the core material comprising a ferrite particle comprising at least one or more temperature compensation-type dielectric components selected from Mg₂TiO₄, MgTiO₃ and MgTi₂O₄.

In the core material of a ferrite carrier for an electrophotographic developer according to the present invention, the total content of the temperature compensation-type dielectric components is desirably 0.2 to 10% by weight.

In the core material of a ferrite carrier for an electrophotographic developer according to the present invention, the contents of the temperature compensation-type dielectric components desirably satisfy the relational expressions (1) and (2) described below.

The content of Mg₂TiO₄>the content of MgTiO₃ (1)

The content of Mg₂TiO₄>the content of MgTi₂O₄ (2)

In the core material of a ferrite carrier for an electrophotographic developer according to the present invention, the ferrite particle comprises Fe, Ti and Mg; and the contents are desirably Fe: 60 to 71% by weight, Ti: 0.5 to 5.5% by weight, and Mg: 0.5 to 3.5% by weight.

The core material of a ferrite carrier for an electrophotographic developer according to the present invention desirably has an oxide film formed on a surface thereof.

The present invention further provides a carrier for an electrophotographic developer in which a surface of the core material of a ferrite carrier is coated with a resin.

The present invention further provides an electrophotographic developer comprising the ferrite carrier and a toner.

The electrophotographic developer according to the present invention can be used also as a refill developer.

The core material of a ferrite carrier for an electrophotographic developer has a high charge amount. The electrophotographic developer comprising the ferrite carrier obtained by coating a surface of the core material of a ferrite carrier with a resin, and a toner is excellent also in the charge stability under every environment.

### DETAILED DESCRIPTION OF THE EMBODIMENTS

Hereinafter, the embodiments for carrying out the present invention will be described.

### <The Core Material of a Ferrite Carrier and the Ferrite Carrier for an Electrophotographic Developer According to the Present Invention>

The core material of a ferrite carrier for an electrophotographic developer according to the present invention comprises a ferrite particle comprising at least one or more temperature compensation-type dielectric components selected from Mg₂TiO₄, MgTiO₃ and MgTi₂O₄. The total amount of these substances is desirably 0.2 to 10% by weight. Making these substances contained can provide a high charge amount, and when made into an electrophotographic developer, is excellent also in the charge stability under every environment.

Any of Mg₂TiO₄, MgTiO₃ and MgTi₂O₄ is typical as a temperature compensation-type dielectric component. Mg₂TiO₄ is of the cubic system, and well compatible with and easily contained in the spinel structure of the same cubic system. MgTi₂O₄ is easily produced if the reducibility is high in one process of a calcination process, a primary sintering process and a regular sintering process for a core material. MgTiO₃ is of a rhombohedral structure, and easily produced if the oxidizability is high in one process of a calcination process, a primary sintering process and a regular sintering process for a core material.

In the core material of a ferrite carrier for an electrophotographic developer according to the present invention, when the total content of temperature compensation-type dielectric components is lower than 0.2% by weight, not only a high charge level cannot be exhibited, but the environmental dependency of the charge amount of the core material of a ferrite carrier becomes large. When the total content of temperature compensation-type dielectric components is higher than 10% by weight, the target charge level and the charge stability can be obtained, but the charge level reaches the top, so the presence of exceeding 10% by weight has no significance. In consideration of the environmental dependency of the charge amount of the core material of a ferrite carrier, the content of temperature compensation-type dielectric components is more preferably 0.2 to 7% by weight, and most preferably 0.2 to 5% by weight.

In the core material of a ferrite carrier for an electrophotographic developer according to the present invention, the contents of the temperature compensation-type dielectric components desirably satisfy the relational equations (1) and (2) described below.

The content of Mg₂TiO₄>the content of MgTiO₃ (1)

The content of Mg₂TiO₄>the content of MgTi₂O₄ (2)

In the case where the contents of the temperature compensation-type dielectric components do not satisfy the relational equation (1), the oxidizability is high in one process of a calcination process, a primary sintering process and a regular sintering process for a core material to produce not only MgTiO₃ but also a large amount of Fe₂O₃, thereby decreasing the magnetization too much and generating carrier scattering, so the carrier has a possibility of becoming unusable as a carrier.

In the case where the contents of the temperature compensation-type dielectric components do not satisfy the relational equation (2), the reducibility is high in one process of a calcination process, a primary sintering process and a regular sintering process for a core material to produce not only MgTi₂O₄ but also a large amount of FeO, thereby decreasing the magnetization too much and generating carrier scattering, so the carrier has a possibility of becoming unusable as a carrier.

The core material of a ferrite carrier for an electrophotographic developer according to the present invention comprises Fe, Ti and Mg. The content of Fe is desirably 60 to 71% by weight, more desirably 60 to 68.5% by weight, and most desirably 60 to 67% by weight. The content of Ti is desirably 0.5 to 5.5% by weight, more desirably 0.5 to 3.5% by weight, and most desirably 0.5 to 1.5% by weight. The content of Mg is desirably 0.5 to 3.5% by weight, more desirably 0.5 to 2.5% by weight, and most desirably 0.5 to 2% by weight. In the compositional range, the core material of a ferrite carrier has a high charge amount.

Since Mg has an electronegativity biased on the plus side, the core material has a very good compatibility with a minus toner, and a developer can easily be obtained which is constituted of a magnesium ferrite carrier containing MgO and a toner for full color and has a high charge amount.

Ti is combined with Fe and contained as Fe₂TiO₄ having a spinel structure, contained in a form in which a part of MgFe₂O₄ and MnFe₂O₄ is substituted with Ti, contained in at least one or more substances selected from Mg₂TiO₄, MgTiO₃ and MgTi₂O₄ as temperature compensation-type dielectric components, or contained in SrTiO₃ as a substance having a high dielectric constant.

Since although Fe₂TiO₄ has a spinel structure as in a soft ferrite, it is more easily oxidized than a soft ferrite having another spinel structure, when the surface oxidation treatment is carried out, insulative Fe₂O₃ is easily produced to hardly cause leakage of the charge; therefore, the charge level of the core material particle can easily be raised.

Mg₂TiO₄, MgTiO₃ and MgTi₂O₄ are temperature compensation-type dielectrics; the relative dielectric constant varies depending on the measurement condition, but the dielectrics having a relative dielectric constant of about 16 to 18 are known; and control of compositions and the manufacturing method is generally carried out so that the temperature coefficient of the dielectric constant is made low for the dielectric constant to be insusceptible to the temperature of the dielectric. By contrast, a ferrite component is affected by the temperature and the dielectric constant varies, and the charge level of a core material of a ferrite carrier varies. Therefore, if the temperature coefficient of the relative dielectric constant of a temperature compensation-type dielectric component is controlled so as to cancel the variation of the relative dielectric constant by the temperature of the ferrite component, the environmental variation of the charge amount of the core material of a ferrite carrier can be suppressed to the minimum. Alternatively, by making at least one or more substances selected from Mg₂TiO₄ MgTiO₃ and MgTi₂O₄ contained in certain proportions according to the temperature variation of the relative dielectric constant of a ferrite component, a fixed relative dielectric constant as a core material of a ferrite carrier can always be held irrespective of the temperature. The relative dielectric constant of a ferrite component varies depending on the measurement condition, but is about 8 to 12 in many cases; and the presence of at least one or more substances selected from Mg₂TiO₄ MgTiO₃ and MgTi₂O₄ in a core material contributes to the direction of raising the charge level of the core material itself of a ferrite carrier.

Since although SrTiO₃ has a high temperature coefficient, and although the relative dielectric constant varies depending on the measurement condition, SrTiO₃ has as high a dielectric constant as 200 or higher, by making SrTiO₃ contained in such a degree as not to affect the environmental dependency, the charge level of the core material of a ferrite carrier can be raised. The content is desirably 0 to 3% by weight; and in the case where the content exceeds 3% by weight, the temperature variation of the dielectric constant of the core material of a ferrite carrier becomes too large, resulting in too large an environmental dependency of the charge amount.

The crystal structures of these Mg₂TiO₄, MgTiO₃, MgTi₂O₄ and SrTiO₃ are measured as follows.

(Measurement of the Crystal Structure: X-Ray Diffractometry)

As a measurement apparatus, “X′PertPRO MPD”, made by PANalytical B.V., was used. As an X-ray source, a Co tube (CoKα line) was used; as an optical system, an integrated optical system and a high-speed detector “X′Celarator” were used; and the measurement was carried out at a continuous scanning of 0.2°/sec. The measurement result was data processed using analysis software “X′Pert HighScore” as in the usual analysis of crystal structures of powder to identify the crystal structure, and the obtained crystal structure was refined to calculate the present ratio in terms of weight. In calculation of the present ratio, since separation of peaks of a magnesium ferrite and Fe₃O₄ is difficult, these were treated as a spinel phase, and respective present ratios of crystal structures other than these were calculated. For the identification of the crystal structures, O was defined as an essential element, and Fe, Mn, Mg, Ti and Sr were defined as elements which had a possibility of being present. With respect to an X-ray source, the measurement can be carried out by a Cu tube with no problem, but since in the case of a sample containing much Fe, the background becomes larger than peaks of measurement objects, use of a Co tube is preferable. With respect to an optical system, a parallel method may provide the similar result, but since the intensity of X-rays is low and the measurement takes much time, the measurement by an integrated optical system is preferable. The speed of the continuous scanning is not especially limited, but in order to obtain a sufficient S/N ratio when the crystal structures were analyzed, the peak intensity of the (113) plane of a spinel structure was made to become 50,000 cps or more, and the measurement was carried out by setting a carrier core material in a sample cell such that the particles did not orient in a specific preferential direction.

With the content of Fe of less than 60% by weight, since the amount of Mg and/or Ti added increases relatively, crystal structures other than the spinel structure of the cubic system constituting a ferrite component is easily produced, and at least one or more temperature compensation-type dielectric components selected from Mg₂TiO₄, MgTiO₃ and MgTi₂O₄ of the cubic system are hardly produced, thus meaning that desired charge properties cannot be obtained. With the content of Fe exceeding 71% by weight, the effect of the addition of Mg and/or Ti cannot be obtained, resulting in making a core material of a ferrite carrier substantially equal to Fe₃O₄. With the content of Mg of less than 0.5% by weight, since at least one or more temperature compensation-type dielectric components selected from Mg₂TiO₄, MgTiO₃ and MgTi₂O₄ cannot be produced in sufficient amounts, there is a possibility of not providing desired charge properties; and with the content of Mg exceeding 3.5% by weight, since the production amount of at least one or more temperature compensation-type dielectric components selected from Mg₂TiO₄, MgTiO₃ and MgTi₂O₄ increases too much, there arises a possibility that the influence of the temperature coefficient of the temperature compensation-type dielectric components becomes large and the environmental variation of the charge amount again becomes large. With the content of Ti of less than 0.5% by weight, since at least one or more temperature compensation-type dielectric components selected from Mg₂TiO₄, MgTiO₃ and MgTi₂O₄ cannot be produced in sufficient amounts, there is a possibility of not providing desired charge properties; and with the content of Ti exceeding 5.5% by weight, since the production amount of at least one or more temperature compensation-type dielectric components selected from Mg₂TiO₄, MgTiO₃ and MgTi₂O₄ increases too much, there arises a possibility that the influence of the temperature coefficient of the temperature compensation-type dielectric components becomes large and the environmental variation of the charge amount again becomes large.

The core material of a ferrite carrier for an electrophotographic developer according to the present invention desirably comprises a small amount of Mn. The content of Mn is desirably 0.001 to 5% by weight, more desirably 0.01 to 4.5% by weight, and most desirably 0.01 to 4.1% by weight. Mn may be added intentionally to improve a balance between resistivity and magnetization according to applications. In this case, particularly an effect can be expected which prevents reoxidation when the core material is discharged from a furnace in a regular sintering. In the case of unintentional addition thereof, it is no problem that a trace amount of Mn as an impurity originated from raw materials is contained. The form of Mn when intentionally added is not especially limited, but MnO₂, Mn₂O₃, Mn₃O₄ and MnCO₃ are easily available in industrial applications, which are preferable.

The core material of a ferrite carrier for an electrophotographic developer according to the present invention may comprise Sr, and the content thereof is 2.0% by weight or less. With the content of Sr exceeding 2.0% by weight, since the core material begins to be hard-ferritized, there arises a risk that the fluidity of a developer on a magnetic brush rapidly becomes deteriorated.

As a crystal structure of an oxide containing Sr and Fe, there is a strontium ferrite represented as SrO.6Fe₂O₃ or SrFe₁₂O₁₉, which many be included in the core material of a ferrite carrier for an electrophotographic developer according to the present invention.

The core material of a ferrite carrier for an electrophotographic developer according to the present invention desirably comprises Si, and the content thereof is desirably 50 to 1,000 ppm, and more desirably 50 to 800 ppm. Making Si contained allows for sintering at a low temperature, and generates no aggregated particles. Additionally, since making Si contained progresses sintering moderately, a high magnetization being a target can be obtained by a regular sintering at a relatively low temperature without making Mn contained in a large amount.

(Contents of Fe, Mg, Ti, Sr, Mn and Si)

The contents of these Fe, Mg, Ti, Sr, Mn and Si are measured as follows.

0.2 g of a carrier core material was weighed; a solution in which 20 ml of 1N hydrochloric acid and 20 ml of 1N nitric acid were added to 60 ml of pure water was heated, and an aqueous solution in which the carrier core material was completely dissolved in the solution was prepared; and the contents of Fe, Mg, Ti, Sr, Mn and Si were measured using an ICP analyzer (ICPS-1000IV, made by Shimadzu Corp.).

(Measurement of the Charge Amount)

The charge amount is measured as follows. That is, 3.5 g of a commercially available styrene-acryl-based negatively chargeable toner (5.5 μm) and 46.5 g of a carrier core material were weighed, and put in a 50-ml glass bottle, and mixed and stirred using a ball mill with the rotation number of the glass bottle adjusted to 100 rpm. The stirring time was set at 30 min. The developer was exposed for 1 hour to an N/N environment (a room temperature of 25° C., a humidity of 55%) and an H/H environment (a room temperature of 32° C., a humidity of 80%), respectively; and thereafter the charge amount was measured using a charge amount measurement device q/m-meter, made by Epping GmbH. A measurement value at 3 min after the start of the measurement was employed as the charge amount.

The core material of a ferrite carrier for an electrophotographic developer according to the present invention desirably has a surface film formed by a surface oxidation treatment. The thickness of the oxide coating film formed by the surface oxidation treatment is preferably 0.1 nm to 5 μm. With the thickness less than 0.1 nm, the effect of the oxide film layer is small; and with the thickness exceeding 5 μm, since apparently the magnetization decreases and the resistivity becomes too high, problems such as a decrease in developability are liable to occur. Reduction may be carried out before the oxidation treatment as required. The thickness of the coating film can be measured from a SEM photograph, with an optical microscope and a laser microscope, each having such a high magnification that permits identification of the formation of the oxide coating film. The oxide coating film may be formed uniformly on the surface of a core material, or may be formed partially.

The core material of a ferrite carrier for an electrophotographic developer according to the present invention has a volume-average particle diameter, as measured by a laser diffraction-type particle size distribution analyzer, of preferably 15 to 120 μm, more preferably 15 to 80 μm, and most preferably 15 to 60 μm. With the volume-average particle diameter less than 15 μm, the carrier beads carry over is liable to occur, which is not preferable. With the volume-average particle diameter exceeding 120 μm, the image quality is liable to deteriorate, which is not preferable. The volume-average particle diameter is measured as follows.

(Volume-Average Particle Diameter)

A measurement device used was a MicroTrack particle size analyzer (Model: 9320-X100), made by Nikkiso Co., Ltd. A dispersion medium used was water.

The core material of a ferrite carrier for an electrophotographic developer according to the present invention desirably has a BET specific surface area of 0.07 to 0.25 m²/g. With the BET specific surface area less than 0.07 m²/g, since a core material has few irregularities on the surface, the anchor effect of a resin after resin coating cannot be obtained and there arises a possibility that the life as a carrier for an electrophotographic developer is shortened; and with the BET specific surface area exceeding 0.25 m²/g, since the irregularities on the core material surface are large enough to make the resin easily infiltrate therein, there is a possibility that desired properties as a carrier for an electrophotographic developer cannot be obtained. The BET specific surface area is measured as follows.

(BET Specific Surface Area)

The BET specific surface area can be determined from a N₂ adsorption amount of a carrier core material measured by making N₂ as an adsorption gas adsorbed on the carrier core material by using an automatic specific surface analyzer GEMINI 2360 (made by Shimadzu Corp.). Here, a measurement tube used when the N₂ adsorption amount was measured was baked under reduced pressure at 50° C. for 2 hours before the measurement. The measurement tube was filled with 5 g of the carrier core material, and the carrier core material was pretreated under reduced pressure at 30° C. for 2 hours, and thereafter N₂ gas was made adsorbed thereon at 25° C. and the adsorption amount was measured. The adsorption amount is a value obtained by drawing an adsorption isotherm and calculating from the BET equation.

The ferrite carrier for an electrophotographic developer according to the present invention is obtained by coating a surface of the core material of a ferrite carrier with a resin.

In the resin-coated ferrite carrier for an electrophotographic developer according to the present invention, the coating amount of the resin is desirably 0.1 to 10% by weight to a core material of a ferrite carrier. With the coating amount less than 0.01% by weight, a sufficient coating layer is difficult to form on a ferrite carrier surface, and even in the case where the charge level of a core material of a ferrite carrier is high, since a decrease in the charge amount of a developer due to toner spent cannot be avoided, fogging and toner scattering occur. With the coating amount exceeding 10% by weight, even in the case where the charge level of a core material of a ferrite carrier is high, the chargeability of a coating resin becomes dominant, and there arises a possibility, although depending on the resin, that a developer does not have a sufficient charge level.

A coating resin used here can suitably be selected according to a toner to be combined, environments used, and the like. The type of the resin is not especially limited, but examples of the resins include fluororesins, acrylic resins, epoxy resins, polyamide resins, polyamide imide resins, polyester resins, unsaturated polyester resins, urea resins, melamine resins, alkyd resins, phenol resins, fluoroacrylic resins, acryl-styrene resins, silicone resins, and modified silicone resins modified with a resin such as acrylic resins, polyester resins, epoxy resins, polyamide resins, polyamide imide resins, alkyd resins, urethane resins and fluororesins. In the present invention, acrylic resins, silicone resins and modified silicone resins are most preferably used.

In order to control the electric resistivity, the charge amount and the charging rate of a carrier, a conductive agent may be added in a coating resin. Since the conductive agent itself has a low electric resistivity, too much an addition amount thereof is liable to cause rapid charge leakage. Therefore, the addition amount is 0.1 to 20.0% by weight, preferably 0.25 to 15.0% by weight, and especially preferably 0.5 to 10.0% by weight, with respect to the solid content of the coating resin. The conductive agent includes conductive carbon and carbon nanotubes, oxides such as titanium oxide and tin oxide, and various types of organic conductive agents.

The coating resin may comprise a charge control agent. Examples of the charge control agent include various types of charge control agents commonly used for toners, and various types of silane coupling agents. This is because, in the case where the exposed area of a core material is controlled so as to become a relatively small area by the coating formation, the charge level decreases in some cases, but addition of various types of charge control agents and silane coupling agents can control the charge level. The types of charge control agents and coupling agents usable are not especially limited, but charge control agents such as nigrosine dyes, quaternary ammonium salts, organic metal complexes or metal-containing monoazo dyes, and aminosilane coupling agents, fluorine-based silane coupling agents or the like are preferable.

### <The Method for Manufacturing a Core Material of a Ferrite Carrier and a Ferrite Carrier for an Electrophotographic Developer According to the Present Invention>

Then, the method for manufacturing a core material of a ferrite carrier and a ferrite carrier for an electrophotographic developer according to the present invention will be described.

The method for manufacturing a core material of a ferrite carrier for an electrophotographic developer according to the present invention comprises pulverizing, mixing and calcining each compound of Fe, Ti and Mg, and Sr as required, and thereafter repulverizing, mixing and granulating the calcined material, and subjecting the obtained granulated material to a primary sintering, a regular sintering, and further a disintegration, a classification and a surface oxidation treatment.

A method for preparing the granulated material by pulverizing, mixing and calcining each compound of Fe, Ti and Mg, and Sr as required, and thereafter repulverizing, mixing and granulating the calcined material is not especially limited; and as the method, conventionally known methods can be employed, and a dry-type method or a wet-type method may be used. At this time, a Mn compound may be added. Fe₂O₃, TiO₂, Mg(OH)₂, and/or MgCO₃, and SrCO₃ as raw materials are mixed; carbon black and/or a binder are further added thereto, and the mixture is calcined in a non-oxidizing atmosphere or a weak reducing atmosphere; and the resultant is desirably in the state of a ferrite precursor in which at least one or more complex oxide phases selected from Fe and Ti, Fe and Sr, Mg and Ti, and Sr and Ti are present in a spinel phase containing at least divalent Fe, and FeO may be further produced in the calcination. After the calcination, the obtained calcined material is again pulverized, mixed and granulated. At this another pulverization and mixing, as required, one or more compounds selected from an Fe compound, a Mg compound, a Ti compound, a Sr compound and a Mn compound may be added as additional raw materials. The form of a compound of the each element when the additional raw material is added is not especially limited, but compounds preferable because commercially easily available in industrial applications are: in the case of an Fe compound, Fe₂O₃, Fe₃O₄ and FeO; in the case of a Mg compound, MgO, Mg(OH)₂, MgCO₃, Mg₂TiO₄, MgTiO₃ and MgTi₂O₄; in the case of a Ti compound, TiO₂, FeTiO₃, Fe₂TiO₄ and Fe₂TiO₅; in the case of a Sr compound, SrO, SrCO₃ and SrTiO₃; and in the case of a Mn compound, MnO₂, Mn₂O₃, Mn₃O₄ and MnCO₃. Although in conventional manufacturing methods, the change in crystal structures necessitates a considerable energy to produce a spinel phase from Fe₂O₃ at the regular sintering, in the case where Fe₂O₃, TiO₂, Mg(OH)₂ and/or MgCO₃, and SrCO₃ are mixed in advance, and carbon black and/or a binder is further added thereto, and the mixture is calcined, the sintering at a low temperature becomes possible because the ferritization is completed only by a necessary minimum change in crystal structures in the regular sintering. As a binder, polyvinyl alcohol and polyvinyl pyrrolidone are preferably used.

In the manufacturing method described above, it is desirable that a Si compound, for example, SiO₂ is added as a sintering aid at the repulverization and mixing, and contained in a certain amount as a final composition. Since such an addition of a Si compound allows for sintering at a low temperature, and generates no aggregated particles, a core material particle having a good shape can easily be obtained.

In the manufacturing method described above, the obtained granulated material is subjected to a primary sintering and a regular sintering. The primary sintering is carried out under a non-oxidation atmosphere at 500 to 1,100° C.

Then, the regular sintering is carried out at 1,220° C. or lower, preferably at 1,100 to 1,200° C. The regular sintering makes the crystal structure firmer, and an effect can be expected which prevents a decrease in the magnetization of the core material particle by the surface oxidation treatment. Since carrying out the primary sintering allows for sintering at a lower temperature in the regular sintering than the case where the primary sintering have not been carried out, not only a core material particle having irregularities is easily made, but a high sphericity can be secured.

In the manufacturing method, as described above, the core material particle has not only a crystal structure originated from raw materials, but a spinel phase containing at least divalent Fe and also at least one or more complex oxide phases selected from Fe and Ti, Fe and Sr, Mg and Ti, and Sr and Ti, in advance, at the time of a granulated material of the core material particle before the regular sintering, and the primary sintering under a non-oxidizing atmosphere at 500 to 1,100° C. is further carried out to be able to promote the ferritization and the crystal growth of temperature compensation-type dielectric components; therefore, also in the regular sintering, sintering at a low temperature of 1,220° C. or lower is allowed.

In the manufacturing method described above, the regular sintering is carried out in an atmosphere of the oxygen concentration of 5% by volume or less. With the oxygen concentration exceeding 5% by volume, the magnetization of a sintered material becomes too low, causing the carrier scattering, which is not preferable. In order to securely produce one or more temperature compensation-type dielectric components selected from Mg₂TiO₄, MgTiO₃ and MgTi₂O₄, and to obtain a highly magnetized core material of a ferrite carrier, an oxygen concentration of 3% by volume or less is preferable, and a non-oxidizing atmosphere (oxygen concentration: 0% by volume) is more preferable.

Thereafter, the core material particle is recovered, dried and deagglomerated to obtain a core material of a ferrite carrier. The core material particle is regulated in the particle size to a desired particle diameter using an existing classification method such as an air classification method, a mesh filtration method or a precipitation method. In the case of carrying out dry-type recovery, the recovery may be carried out by a cyclone or the like.

Thereafter, as required, the core material particle is subjected to an oxide film treatment by heating the surface at a low temperature to regulate the electric resistivity. The oxide film treatment is carried out by a heat treatment using a common furnace such as a rotary electric furnace or a batch-type electric furnace, for example, at 300 to 800° C., preferably at 450 to 700° C. In order to form an oxide film uniformly on a core material particle, use of a rotary electric furnace is preferable.

A ferrite carrier for an electrophotographic developer according to the present invention is obtained by coating a surface of the core material of a ferrite carrier with a resin described above to form a resin coating. The coating can be carried out using a known coating method, for example, a brush coating method, a spray dry system using a fluidized bed, a rotary dry system and a dip-and-dry method using a universal stirrer. In order to improve the surface coverage, the method using a fluidized bed is preferable.

In the case where the resin is baked after the core material of a ferrite carrier is coated with the resin, the baking may be carried out using either of an external heating system and an internal heating system, for example, a fixed or fluidized electric furnace, a rotary electric furnace, a burner furnace and a microwave system. In the case where a UV curing resin is used, a UV heater is used. The baking temperature depends on a resin used, but needs to be a temperature equal to or higher than the melting point or the glass transition point; and for a thermosetting resin, a condensation-crosslinking resin or the like, the temperature needs to be raised to a temperature at which the curing progresses fully.

### <The Electrophotographic Developer According to the Present Invention>

Then, the electrophotographic developer according to the present invention will be described.

The electrophotographic developer according to the present invention comprises the above-mentioned ferrite carrier for an electrophotographic developer and a toner.

The toner particle constituting the electrophotographic developer according to the present invention includes a pulverized toner particle manufactured by a pulverizing method and a polymerized toner particle manufactured by a polymerizing method. In the present invention, the toner particles obtained by either of the methods can be used.

The pulverized toner particle can be obtained by sufficiently mixing, for example, a binding resin, a charge control agent and a colorant by a mixer such as a Henschel mixer, then melting and kneading the mixture by a twin-screw extruder or the like, cooling, then pulverizing and classifying the extruded material, and adding external additives to the classified material, and then mixing the mixture by a mixer or the like.

The binding resin constituting the pulverized toner particle is not especially limited, but includes polystyrene, chloropolystyrene, styrene-chlorostyrene copolymers, styrene-acrylate copolymers, styrene-methacrylic acid copolymers, and additionally rosin-modified maleic resins, epoxy resins, polyester resins and polyurethane resins. These are used singly or as a mixture thereof.

The charge control agent usable is an optional one. For example, for a positively chargeable toner, the charge control agent includes nigrosine dyes and quaternary ammonium salts; for a negatively chargeable toner, it includes metal-containing monoazo dyes.

The colorant (coloring agent) usable is a conventionally known dye and pigment. For example, usable are carbon black, phthalocyanine blue, Permanent Red, chrome yellow, phthalocyanine green and the like. Besides, external additives, such as silica powder and titania, to improve the fluidity and aggregation resistance of a toner may be added depending on the toner particle.

The polymerized toner particle is a toner particle manufactured by a known method such as a suspension polymerization method, an emulsion polymerization method, an emulsion aggregation method, an ester extension polymerization method or a phase transition emulsion method. Such a polymerized toner particle is obtained, for example, by mixing and stirring a colorant-dispersed liquid in which a colorant is dispersed in water using a surfactant, a polymerizable monomer, a surfactant and a polymerization initiator in an aqueous medium to emulsify and disperse and polymerize the polymerizable monomer in the aqueous medium under stirring and mixing, thereafter adding a salting-out agent to salt out a polymer particle, and filtering, washing and drying the particle obtained by the salting-out. Thereafter, as required, external additives to impart functions may be added to the dried toner particle.

When the polymerized toner particle is manufactured, a fixation improving agent and a charge control agent may be blended in addition to the polymerizable monomer, the surfactant, the polymerization initiator and the colorant, whereby various characteristics of a polymerized toner particle thus obtained can be controlled and improved. In order to improve the dispersibility of the polymerizable monomer in the aqueous medium, and regulate the molecular weight of a polymer obtained, a chain transfer agent may be further used.

The polymerizable monomer used for manufacture of the polymerized toner particle is not especially limited, but examples of the monomers include styrene and its derivatives, ethylenic unsaturated monoolefins such as ethylene and propylene, halogenated vinyls such as vinyl chloride, vinyl esters such as vinyl acetate, and α-methylene aliphatic monocarboxylates such as methyl acrylate, ethyl acrylate, methyl methacrylate, ethyl methacrylate, 2-ethylhexyl methacrylate, acrylic acid dimethyl amino ester and methacrylic acid diethyl amino ester.

Conventionally known dyes and pigments can be used as the colorant (coloring material) in preparation of the polymerized toner particle. For example, usable are carbon black, phthalocyanine blue, Permanent Red, chrome yellow, phthalocyanine green and the like. These colorants may be modified on their surface using a silane coupling agent, a titanium coupling agent or the like.

The surfactant usable in manufacture of the polymerized toner particle is an anionic surfactant, a cationic surfactant, an amphoteric surfactant and a nonionic surfactant.

Here, the anionic surfactant includes fatty acid salts such as sodium oleate and castor oil, alkylsulfate esters such as sodium laurylsulfate and ammonium laurylsulfate, alkylbenzenesulfonate salts such as sodium dodecylbenzenesulfonate, alkylnaphthalenesulfonates, alkylphosphate salts, naphthalenesulfonic acid-formalin condensates and polyoxyethylene alkylsulfate salts. The nonionic surfactant includes polyoxyethylene alkyl ethers, polyoxyethylene fatty acid esters, sorbitan fatty acid esters, polyoxyethylene alkylamines, glycerol, fatty acid esters and oxyethylene-oxypropylene block polymers. Furthermore, the cationic surfactant includes alkylamine salts such as laurylamine acetate, and quaternary ammonium salts such as lauryltrimethylammonium chloride and stearyltrimethylammonium chloride. Then, the amphoteric surfactant includes aminocarboxylate salts and alkylamino acids.

A surfactant as described above can be used usually in an amount in the range of 0.01 to 10% by weight with respect to a polymerizable monomer. Such a surfactant influences the dispersion stability of a monomer, and influences also the environmental dependency of a polymerized toner particle obtained. The use of the surfactant in the range described above is preferable from the viewpoint of securing the dispersion stability of the monomer and reducing the environmental dependency of the polymerized toner particle.

For manufacture of a polymerized toner particle, a polymerization initiator is usually used. The polymerization initiator includes a water-soluble polymerization initiator and an oil-soluble polymerization initiator. In the present invention, either of them can be used. Examples of the water-soluble polymerization initiators usable in the present invention include persulfate salts such as potassium persulfate and ammonium persulfate, and water-soluble peroxide compounds. Examples of the oil-soluble polymerization initiators include azo compounds such as azobisisobutyronitrile, and oil-soluble peroxide compounds.

In the case of using a chain transfer agent in the present invention, examples of the chain transfer agents include mercaptans such as octylmercaptan, dodecylmercaptan and tert-dodecylmercaptan, and carbon tetrabromide.

In the case where a polymerized toner particle used in the present invention comprises a fixability improving agent, the fixability improving agent usable is natural waxes such as carnauba wax, and olefinic waxes such as polypropylene and polyethylene.

In the case where the polymerized toner particle used in the present invention comprises a charge control agent, the charge control agent used is not especially limited, and usable are nigrosine dyes, quaternary ammonium salts, organic metal complexes, metal-containing monoazo dyes, and the like.

External additives used for improving the fluidity and the like of a polymerized toner particle include silica, titanium oxide, barium titanate, fluororesin microparticles and acrylic resin microparticles. These may be used singly or in combination thereof.

The salting-out agent used for separation of a polymerized particle from an aqueous medium includes metal salts such as magnesium sulfate, aluminum sulfate, barium chloride, magnesium chloride, calcium chloride and sodium chloride.

The toner particle manufactured as described above has a volume-average particle diameter in the range of 2 to 15 μm, and preferably 3 to 10 μm, and the polymerized toner particle has a higher uniformity of particles than the pulverized toner particle. If the toner particle is less than 2 μm, the chargeability decreases and fogging and toner scattering are liable to occur; and the toner particle diameter exceeding 15 μm causes the degradation of image quality.

The carrier and the toner manufactured as described above are mixed to obtain an electrophotographic developer. The mixing ratio of the carrier and the toner (toner weight/(carrier weight+toner weight)), that is, the toner concentration is preferably set at 3 to 15% by weight. A toner concentration less than 3% by weight hardly provides a desired image density; and a toner concentration exceeding 15% by weight is liable to generate toner scattering and fogging.

The electrophotographic developer according to the present invention can be used as a refill developer. The mixing ratio of the carrier and the toner (toner weight/carrier weight), that is, the toner concentration is preferably set at 100 to 3,000% by weight.

The electrophotographic developer according to the present invention, prepared as described above, can be used in copying machines, printers, FAXs, printing machines and the like, which use a digital system using a development system in which electrostatic latent images formed on a latent image holder having an organic photoconductive layer are reversely developed with a magnetic brush of a two-component developer having a toner and a carrier while a bias electric field is being impressed. The electrophotographic developer is also applicable to full-color machines and the like using an alternating electric field, in which when a development bias is impressed from a magnetic brush to an electrostatic latent image side, an AC bias is superimposed on a DC bias.

Hereinafter, the present invention will be described specifically by way of Examples and the like.

### EXAMPLE 1

Fe₂O₃, Mg(OH)₂, TiO₂ and Mn₃O₄ were weighed so as to become 7.8 mol of Fe, 0.4 mol of Mg, 0.15 mol of Ti and 0.1 mol of Mn, and pelletized by a roller compactor. At this time, in order to promote the sintering, and to reduce trivalent Fe, 0.5% by weight of activated carbon was added; and the obtained pellet was calcined at 1,000° C. in an atmosphere of an oxygen concentration of 0% by volume in a rotary sintering furnace to progress the ferritization and simultaneously reduce a part of iron oxide while organic substances and gaseous components were being removed.

The obtained calcined material was pulverized by a beads mill. On the pulverization, a dispersion obtained by dispersing SiO₂ of 12 nm in average primary particle diameter in a proportion of the solid content thereof of 20% by weight to water by using a homogenizer T65D ULTRA-TURRAX, made by IKA-Werke GmbH & Co. KG, was added in 0.07% by weight with respect to the solid content of the slurry in terms of SiO₂ solid content; PVA as a binder component was added to be 3.2% by weight with respect to the solid content of the slurry; and a polycarboxylate-based dispersant was added so that the viscosity of the slurry became 2 to 3 poises. D₅₀ of the particle diameter of the slurry at this time was 2 μm. The obtained pulverized slurry was again granulated by a spray drier, and subjected to a primary sintering in a rotary sintering furnace under a non-oxidizing atmosphere (oxygen concentration: 0% by volume) at 800° C. to progress the ferritization and simultaneously reduce a part of iron oxide while organic substances were being removed.

Coarse particles were removed from the primarily sintered material using a sieve of #80 mesh, and thereafter the material was sintered at 1,185° C. under a non-oxidizing atmosphere (oxygen concentration: 0% by volume) for 16 hours to obtain a sintered material. The obtained sintered material was disintegrated, classified and magnetically selected to obtain a carrier core material particle.

The obtained carrier core material particle was further subjected to a surface oxidation treatment in a rotary electric furnace at a surface oxidation treatment temperature of 630° C. under the condition of the air atmosphere to obtain a surface oxidation-treated carrier core material particle.

### EXAMPLE 2

As shown in Table 1, a carrier core material particle was obtained as in Example 1, except for having altered the Fe raw material to 15 mol.

### EXAMPLE 3

As shown in Table 1, a carrier core material particle was obtained as in Example 1, except for having altered the Mn raw material to 0.5 mol.

### EXAMPLE 4

As shown in Table 1, a carrier core material particle was obtained as in Example 1, except for having altered the Ti raw material to 0.2 mol.

### EXAMPLE 5

As shown in Table 1, a carrier core material particle was obtained as in Example 1, except for having altered the Ti raw material to 0.07 mol.

### EXAMPLE 6

As shown in Table 1, a carrier core material particle was obtained as in Example 1, except for having altered the Mg raw material to 0.8 mol.

### EXAMPLE 7

As shown in Table 1, a carrier core material particle was obtained as in Example 1, except for having altered the Mg raw material to 0.13 mol.

### EXAMPLE 8

As shown in Table 3, a carrier core material particle was obtained as in Example 1, except for having altered the surface oxidation treatment temperature to 700° C.

### EXAMPLE 9

As shown in Table 3, a carrier core material particle was obtained as in Example 1, except for having altered the surface oxidation treatment temperature to 450° C.

### EXAMPLE 10

As shown in Table 1, a carrier core material particle was obtained as in Example 1, except for having added 0.06 mol of a Sr raw material.

### Comparative Example 1

A carrier core material particle was obtained as in Example 1, except that: as shown in Table 1, raw materials were 15.84 mol of an Fe raw material, 0.65 mol of a Mg raw material, 2.67 mol of a Li raw material and 0.1 mol of a Ca raw material; no activated carbon was added; no calcination was carried out; D₅₀ of the slurry particle diameter by the regular granulation was made 3.5 μm; further as shown in Table 2, the primary sintering was carried out at 650° C. in an air atmosphere, and the regular sintering was carried out at 1,210° C. in an air atmosphere; and as shown in Table 3, no surface oxidation treatment was carried out.

### Comparative Example 2

A carrier core material particle was obtained as in Example 1, except that: as shown in Table 1, raw materials were 10 mol of an Fe raw material, 1 mol of a Mg raw material, 0.02 mol of a Sr raw material and 4 mol of a Mn raw material; no activated carbon was added; the calcination was carried out at 900° C. in the air atmosphere; D₅₀ of the slurry particle diameter by the regular granulation was made 3.5 μm; further as shown in Table 2, the primary sintering was carried out at 700° C. in an air atmosphere, and the regular sintering was carried out at 1,235° C. in an atmosphere of an oxygen concentration of 1.5% by volume; and as shown in Table 3, no surface oxidation treatment was carried out.

### Comparative Example 3

A carrier core material particle was obtained as in Example 1, except that: as shown in Table 1, raw materials were 10 mol of an Fe raw material, 1 mol of a Mg raw material, 0.02 mol of a Sr raw material and 4 mol of a Mn raw material; no activated carbon was added; the calcination was carried out at 930° C. in the air atmosphere; D₅₀ of the slurry particle diameter by the regular granulation was made 2 μm; further as shown in Table 2, the primary sintering was carried out at 700° C. in an air atmosphere, and the regular sintering was carried out at 1,130° C. in an atmosphere of an oxygen concentration of 0.5% by volume; and as shown in Table 3, no surface oxidation treatment was carried out.

### Comparative Example 4

A carrier core material particle was obtained as in Example 1, except that: as shown in Table 1, raw materials were 15.34 mol of an Fe raw material, 0.25 mol of a Mg raw material, 2.67 mol of a Li raw material and 1 mol of a Mn raw material; no activated carbon was added; the calcination was carried out at 930° C. in the air atmosphere; D₅₀ of the slurry particle diameter by the regular granulation was made 2 μm; further as shown in Table 2, the primary sintering was carried out at 650° C. in an air atmosphere, and the regular sintering was carried out at 1,145° C. in an atmosphere of an oxygen concentration of 1% by volume; and as shown in Table 3, no surface oxidation treatment was carried out.

### Comparative Example 5

A carrier core material particle was obtained as in Example 1, except that: as shown in Table 1, raw materials were 10.1 mol of an Fe raw material, 0.25 mol of a Mg raw material and 4.7 mol of a Mn raw material; no activated carbon was added; no calcination was carried out; D₅₀ of the slurry particle diameter by the regular granulation was made 2 μm; further as shown in Table 2, the primary sintering was carried out at 650° C. in an air atmosphere, and the regular sintering was carried out at 1,290° C. in a non-oxidizing atmosphere (oxygen concentration: 0% by volume); and as shown in Table 3, the surface oxidation treatment was carried out at 550° C.

For Examples 1 to 10 and Comparative Examples 1 to 5, Table 1 shows feeding raw material proportions of carrier core materials, calcination conditions (calcination temperature, calcination atmosphere) and regular granulation conditions (slurry particle diameter, Si amount, binder amount); and Table 2 shows primary sintering conditions (sintering temperature, sintering atmosphere) and regular sintering conditions (sintering temperature, sintering atmosphere) of carrier core materials, and chemical analyses before the surface oxidation treatment. Table 3 shows X-ray diffractions before the surface oxidation treatment and the magnetizations of core materials; and Table 4 shows volume-average particle diameters before the oxidation treatment, the BET specific surface areas and charge properties after the surface oxidation treatment [which involve charge amounts (low-temperature and low-humidity (L/L), normal-temperature and normal-humidity (N/N), high-temperature and high-humidity (H/H)) and absolute values of differences in charge amount between the low-temperature and low-humidity (L/L) and the high-temperature and high-humidity (H/H), for which a toner of 5.8 μm in volume-average particle diameter was used]. Table 5 shows surface oxidation treatment temperatures, volume-average particle diameters after the oxidation treatment, BET specific surface areas, charge properties after the surface oxidation treatment [which involve charge amounts (low-temperature and low-humidity (L/L), normal-temperature and normal-humidity (N/N), high-temperature and high-humidity (H/H)) and absolute values of differences in charge amount between the low-temperature and low-humidity (L/L) and the high-temperature and high-humidity (H/H), for which a toner of 5.5 μm was used]. In Comparative Examples 1 to 4, no oxidation treatment was carried out. In Table 3, the magnetization of a core material was measured as follows.

(Magnetization)

The magnetization is measured as follows. That is, the measurement was carried out using an integration-type B-H tracer BHU-60 (made by Riken Denshi Co., Ltd.). An H coil for measuring a magnetic field and a 4πI coil for measuring a magnetization are placed between electromagnets. In this case, a sample is placed in the 4πI coil. The current of the electromagnets is varied to vary the magnetic field H, and outputs of the H coil and the 4πI coil are integrated, respectively; and a hysteresis loop is drawn on a recording paper with the H output on X axis and the output of the 4πI coil on Y axis. The measurement conditions were: a sample filling amount was about 1 g; a sample filling cell had an inner diameter of 7 mmφ±0.02 mm, a height of 10 mm±0.1 mm; and the 4πI coil had the winding number of 30.

TABLE 1

| | | | | | | | | | Calcination | | | | |
|---|---|---|---|---|---|---|---|---|---|---|---|---|---|
| | | | | | | | | | | Calcination | Regular granulation | | |
| | Formulation (feeding mol) | | | | | | | | | atmosphere | Slurry | | |
| | | | | | | | | Activated | Calcination | (oxygen | particle | | Binder |
| | | | | | | | | carbon | temperature | concentration | diameter | Si (wt %) | (PVA) |
| | Fe | Ti | Mg | Sr | Li | Mn | Ca | (wt %) *1 | (° C.) | vol %) | (μm) | *2 | (wt %) *3 |
| Ex. 1 | 7.8 | 0.15 | 0.4 | 0 | 0 | 0.1 | 0 | 0.5 | 1000 | 0 | 2 | 0.07 | 3.2 |
| Ex. 2 | 15 | 0.15 | 0.4 | 0 | 0 | 0.1 | 0 | 0.5 | 1000 | 0 | 2 | 0.07 | 3.2 |
| Ex. 3 | 7.8 | 0.15 | 0.4 | 0 | 0 | 0.5 | 0 | 0.5 | 1000 | 0 | 2 | 0.07 | 3.2 |
| Ex. 4 | 7.8 | 0.2 | 0.4 | 0 | 0 | 0.1 | 0 | 0.5 | 1000 | 0 | 2 | 0.07 | 3.2 |
| Ex. 5 | 7.8 | 0.07 | 0.4 | 0 | 0 | 0.1 | 0 | 0.5 | 1000 | 0 | 2 | 0.07 | 3.2 |
| Ex. 6 | 7.8 | 0.15 | 0.8 | 0 | 0 | 0.1 | 0 | 0.5 | 1000 | 0 | 2 | 0.07 | 3.2 |
| Ex. 7 | 7.8 | 0.15 | 0.13 | 0 | 0 | 0.1 | 0 | 0.5 | 1000 | 0 | 2 | 0.07 | 3.2 |
| Ex. 8 | 7.8 | 0.15 | 0.4 | 0 | 0 | 0.1 | 0 | 0.5 | 1000 | 0 | 2 | 0.07 | 3.2 |
| Ex. 9 | 7.8 | 0.15 | 0.4 | 0 | 0 | 0.1 | 0 | 0.5 | 1000 | 0 | 2 | 0.07 | 3.2 |
| Ex. 10 | 7.8 | 0.15 | 0.4 | 0.06 | 0 | 0.1 | 0 | 0.5 | 1000 | 0 | 2 | 0.07 | 3.2 |
| Com. Ex. 1 | 15.84 | 0 | 0.65 | 0 | 2.67 | 0 | 0.1 | 0 | — | — | 3.5 | — | 3.2 |
| Com. Ex. 2 | 10 | 0 | 1 | 0.02 | 0 | 4 | 0 | 0 | 900 | in the air | 3.5 | — | 3.2 |
| Com. Ex. 3 | 10 | 0 | 1 | 0.02 | 0 | 4 | 0 | 0 | 930 | in the air | 2 | — | 3.2 |
| Com. Ex. 4 | 15.34 | 0 | 0 | 0 | 2.67 | 1 | 0 | 0 | 930 | in the air | 2 | — | 3.2 |
| Com. Ex. 5 | 10.1 | 0 | 0.25 | 0 | 0 | 4.7 | 0 | 0 | — | — | 2 | — | 3.2 |

*1: A value to the weight of the pellet
*2: A value in terms of SiO₂ solid content to the solid content of the slurry
*3: A value to the solid content of the slurry

TABLE 2

| | Primary sintering | | | | | | | | | | | |
|---|---|---|---|---|---|---|---|---|---|---|---|---|
| | | Sintering | Regular sintering | | | | | | | | | |
| | | atmosphere | | Sintering | | | | | | | | |
| | Sintering | (oxygen | Sintering | atmosphere (oxygen | Chemical analysis (ICP) . before the surface | | | | | | | |
| | temperature | concentration | temperature | concentration | oxidation treatment (wt %) | | | | | | | |
| | (° C.) | vol %) | (° C.) | vol %) | Fe | Ti | Mg | Sr | Li | Mn | Ca | Si |
| Ex. 1 | 800 | 0 vol % | 1185 | 0 vol % | 67.99 | 1.12 | 1.51 | 0 | 0 | 0.85 | 0 | 0.05 |
| Ex. 2 | 800 | 0 vol % | 1185 | 0 vol % | 70.02 | 0.60 | 0.81 | 0 | 0 | 0.45 | 0 | 0.06 |
| Ex. 3 | 800 | 0 vol % | 1185 | 0 vol % | 64.90 | 1.06 | 1.44 | 0 | 0 | 4.09 | 0 | 0.06 |
| Ex. 4 | 800 | 0 vol % | 1185 | 0 vol % | 67.54 | 1.48 | 1.50 | 0 | 0 | 0.85 | 0 | 0.05 |
| Ex. 5 | 800 | 0 vol % | 1185 | 0 vol % | 68.72 | 0.52 | 1.53 | 0 | 0 | 0.86 | 0 | 0.06 |
| Ex. 6 | 800 | 0 vol % | 1185 | 0 vol % | 66.10 | 1.08 | 2.95 | 0 | 0 | 0.83 | 0 | 0.06 |
| Ex. 7 | 800 | 0 vol % | 1185 | 0 vol % | 69.32 | 1.14 | 0.50 | 0 | 0 | 0.92 | 0 | 0.05 |
| Ex. 8 | 800 | 0 vol % | 1185 | 0 vol % | 67.99 | 1.12 | 1.51 | 0 | 0 | 0.85 | 0 | 0.05 |
| Ex. 9 | 800 | 0 vol % | 1185 | 0 vol % | 67.99 | 1.12 | 1.51 | 0 | 0 | 0.85 | 0 | 0.06 |
| Ex. 10 | 800 | 0 vol % | 1185 | 0 vol % | 67.32 | 1.10 | 1.50 | 0.81 | 0 | 0.84 | 0 | 0.05 |
| Com. Ex. 1 | 650 | in the air | 1210 | in the air | 66.29 | 0 | 1.18 | 0 | 1.38 | 0 | 0.29 | 0.05 |
| Com. Ex. 2 | 700 | in the air | 1235 | 1.5 vol % | 49.65 | 0 | 2.16 | 0.15 | 0 | 19.53 | 0 | 0.06 |
| Com. Ex. 3 | 700 | in the air | 1130 | 0.5 vol % | 49.65 | 0 | 2.16 | 0.15 | 0 | 19.53 | 0 | 0.05 |
| Com. Ex. 4 | 650 | in the air | 1145 | 1 vol % | 64.13 | 0 | 0 | 0 | 1.38 | 4.11 | 0 | 0.12 |
| Com. Ex. 5 | 650 | in the air | 1290 | 0 vol % | 57.49 | 0 | 0.48 | 0 | 0 | 14.13 | 0 | 0.05 |

TABLE 3

| | X-Ray Diffraction (XRD) . before the surface oxidation treatment | | | | | | | | |
|---|---|---|---|---|---|---|---|---|---|
| | Content | Content | Content | Total content of | Content | | | | |
| | of | of | of | temperature | of | Content of | Content | Content | Magnetization of |
| | Mg₂TiO₄ | MgTiO₃ | MgTi₂O₄ | compensation-type | SrTiO₃ | SrO•6(Fe₂O₃) | of FeO | of Fe₂O₃ | the core material |
| | (wt %) | (wt %) | (wt %) | dielectrics | (wt %) | (wt %) | (wt %) | (wt %) | (B-H) (emu/g) |
| Ex. 1 | 3.6 | — | — | 3.6 | — | — | 0.4 | — | 78 |
| Ex. 2 | 1.8 | — | — | 1.8 | — | — | 0.8 | — | 83 |
| Ex. 3 | 3.7 | — | 0.7 | 4.4 | — | — | 4.5 | — | 75 |
| Ex. 4 | 4.4 | — | — | 4.4 | — | — | — | — | 77 |
| Ex. 5 | 1.5 | — | 0.6 | 2.1 | — | — | 3.5 | — | 79 |
| Ex. 6 | 2.5 | — | — | 2.5 | — | — | 0.6 | — | 72 |
| Ex. 7 | 0.5 | — | — | 0.5 | — | — | 0.9 | — | 82 |
| Ex. 8 | 3.6 | — | — | 3.6 | — | — | 0.4 | — | 78 |
| Ex. 9 | 3.6 | — | — | 3.6 | — | — | 0.4 | — | 78 |
| Ex. 10 | 1.2 | 0.7 | — | 1.9 | 1.4 | 1.5 | — | 1.3 | 73 |
| Com. Ex. 1 | — | — | — | — | — | — | — | — | 65 |
| Com. Ex. 2 | — | — | — | — | — | 6.9 | — | — | 67 |
| Com. Ex. 3 | — | — | — | — | — | 5.8 | — | — | 68 |
| Com. Ex. 4 | — | — | — | — | — | — | — | — | 69 |
| Com. Ex. 5 | — | — | — | — | — | — | — | — | 79 |

* - indicates no detection

TABLE 4

| | | | Charge properties (before the surface oxidation | | | |
|---|---|---|---|---|---|---|
| | | | treatment) | | | |
| | | | | | | L/L charge |
| | Volume-average | BET specific | L/L charge | N/N charge | H/H charge | amount − H/H |
| | particle | surface area | amount | amount | amount | charge amount |
| | diameter (μm) | (m²/g) | (μC/g) | (μC/g) | (μC/g) | (μC/g) |
| Ex. 1 | 32.54 | 0.1062 | −58.21 | −57.64 | −57.08 | 1.13 |
| Ex. 2 | 31.74 | 0.0950 | −52.14 | −51.35 | −50.72 | 1.42 |
| Ex. 3 | 33.08 | 0.0983 | −54.92 | −54.37 | −54.04 | 0.88 |
| Ex. 4 | 32.98 | 0.1236 | −52.76 | −52.75 | −52.05 | 0.71 |
| Ex. 5 | 33.22 | 0.0812 | −51.43 | −50.34 | −50.20 | 1.23 |
| Ex. 6 | 32.49 | 0.1107 | −59.95 | −59.61 | −59.20 | 0.75 |
| Ex. 7 | 31.95 | 0.1106 | −53.72 | −53.35 | −53.24 | 0.48 |
| Ex. 8 | 32.54 | 0.0954 | −59.02 | −58.87 | −57.49 | 1.53 |
| Ex. 9 | 32.54 | 0.1153 | −55.12 | −54.28 | −54.05 | 1.07 |
| Ex. 10 | 33.61 | 0.1024 | −62.53 | −61.47 | −59.83 | 2.70 |
| Com. Ex. 1 | 35.42 | 0.0715 | −28.12 | −24.96 | −17.21 | 10.91 |
| Com. Ex. 2 | 35.18 | 0.0840 | −30.34 | −26.85 | −21.34 | 9.00 |
| Com. Ex. 3 | 36.98 | 0.1301 | −41.12 | −37.27 | −31.38 | 9.74 |
| Com. Ex. 4 | 37.65 | 0.1528 | −18.12 | −15.57 | −10.49 | 7.63 |
| Com. Ex. 5 | 34.21 | 0.0825 | −33.98 | −29.48 | −27.07 | 6.91 |

TABLE 5

| | Surface | | | Charge properties (after the surface oxidation treatment) | | | |
|---|---|---|---|---|---|---|---|
| | oxidation | | | | | | L/L charge |
| | treatment | Volume-average | BET specific | | | | amount − H/H |
| | temperature | particle | surface area | L/L charge | N/N charge | H/H charge | charge amount |
| | (° C.) | diameter (μm) | (m²/g) | amount (μC/g) | amount (μC/g) | amount (μC/g) | (μC/g) |
| Ex. 1 | 630 | 35 | 0.0944 | −74.22 | −73.06 | −72.89 | 1.33 |
| Ex. 2 | 630 | 35 | 0.0811 | −68.35 | −68.51 | −68.17 | 0.18 |
| Ex. 3 | 630 | 35 | 0.0909 | −72.13 | −71.98 | −72.56 | 0.43 |
| Ex. 4 | 630 | 35 | 0.1129 | −69.56 | −69.31 | −69.22 | 0.34 |
| Ex. 5 | 630 | 35 | 0.0765 | −68.79 | −67.44 | −67.03 | 1.76 |
| Ex. 6 | 630 | 35 | 0.0981 | −78.56 | −77.99 | −78.03 | 0.53 |
| Ex. 7 | 630 | 35 | 0.0933 | −69.45 | −69.31 | −68.12 | 0.33 |
| Ex. 8 | 700 | 35 | 0.0967 | −77.66 | −76.02 | −75.81 | 1.85 |
| Ex. 9 | 450 | 35 | 0.0850 | −71.99 | −72.93 | −72.41 | 0.42 |
| Ex. 10 | 630 | 35 | 0.1024 | −81.61 | −80.78 | −79.21 | 2.40 |
| Com. Ex. 5 | 550 | 35 | 0.0821 | −45.33 | −39.81 | −36.11 | 9.22 |

As is clear from the results of Table 1 to Table 5, Examples 1 to 10 each provided a core material of a ferrite carrier which had a sufficiently high charge amount by itself, and a very small environmental dependency of the charge amount. Particularly Example 10 provided a core material of a ferrite carrier which contained SrTiO₃, and had the excellent environmental dependency and a very high charge level. By contrast, Comparative Examples 1, 4 and 5 each gave a considerably low charge level of a core material of a ferrite carrier because these contained no Mg. Comparative Examples 2 and 3 also gave the result of being inferior in the charge level of a core material of a ferrite carrier to Examples 1 to 10 although Comparative Examples 2 and 3 contained Mg. Comparative Examples 1 to 5 further gave the result of being inferior in the environmental dependency of the charge amount to Examples 1 to 10 because any of Comparative Examples 1 to 5 did not contain at least one or more temperature compensation-type dielectric components selected from Mg₂TiO₄, MgTiO₃ and MgTi₂O₄. Particularly Comparative Example 1 and Comparative Example 4 gave the result of being inferior in the environmental dependency of the charge amount even to Comparative Examples 2, 3 and 5 because Comparative Examples 1 and 4 contained Li.

### EXAMPLE 11

A carrier core material particle of 55.22 μm in average particle diameter was fabricated by the same method as in Example 1, and coated with an acryl-modified silicone resin KR-9706, made by Shin-Etsu Silicones Co., Ltd., as a coating resin by a fluidized-bed coating apparatus. At this time, the resin solution used was prepared by weighing the resin so that the solid content of the resin became 1% by weight with respect to the carrier core material, and adding a solvent in which toluene and MEK were mixed in 3:1 in weight ratio so that the solid content of the resin became 10% by weight. After the resin was applied, the coated carrier core material was dried for 3 hours under stirring by a heat-exchange type stirring and heating apparatus set at 200° C. to completely eliminate volatile contents, to obtain a resin-coated carrier.

### EXAMPLE 12

A carrier core material particle of 55.22 μm in average particle diameter was fabricated by the same method as in Example 1, and coated with a silicone resin KR-350 made by Shin-Etsu Silicones Co., Ltd., an aluminum-based catalyst CAT-AC made by Dow Corning Toray Co., Ltd., an aminosilane coupling agent KBM-603 made by Shin-Etsu Silicones Co., Ltd., and Ketjen Black EC600JD made by Lion Corp. as a coating resin by a fluidized-bed coating apparatus. At this time, the resin solution used was prepared by weighing the silicone resin so that the solid content of the resin became 1.5% by weight with respect to the carrier core material, and adding 2% by weight of the aluminum-based catalyst CAT-AC, 10% by weight of the aminosilane coupling agent KBM-603, and 15% by weight of Ketjen Black EC600JD thereto with respect to the solid content of the resin, and further adding toluene so that the solid content of the resin became 10% by weight, predispersing the mixture for 3 min by a homogenizer T65D ULTRA-TURRAX, made by IKA-Werke GmbH & Co. KG, and thereafter dispersing the resultant for 5 min by a vertical beads mill. After the resin was applied, the coated carrier core material was dried for 3 hours by a hot-air drier set at 250° C. to completely eliminate volatile contents, to obtain a resin-coated carrier.

### EXAMPLE 13

A carrier core material particle of 55.22 μm in average particle diameter was fabricated by the same method as in Example 1, and coated with an acrylic resin Dianal BR-80, made by Mitsubishi Rayon Co., Ltd., as a coating resin with a universal stirrer. At this time, the resin solution used was prepared by weighing the resin so that the solid content of the resin became 0.5% by weight with respect to the carrier core material, and adding toluene so that the solid content of the resin became 10% by weight. Since the resin was a powder, the resin solution was boiled so as to become at 50° C. so that the resin powder dissolved completely. After the resin was applied, the coated carrier core material was dried for 2 hours by a hot-air drier set at 145° C. to completely eliminate volatile contents, to obtain a resin-coated carrier.

### Comparative Example 6

A carrier core material particle of 58.51 μm in average particle diameter was fabricated by the same method as in Comparative Example 2, and coated with the resin by the same method as in Example 12 to obtain a resin-coated carrier.

For Examples 11 to 13 and Comparative Example 6, 47.5 g of the carrier and 2.5 g of a toner were weighed, placed in a 50-cc glass bottle, stirred and mixed for 30 min by a ball mill at a rotation number of 100 rpm to obtain a developer for measuring the charge amount for the toner concentration of 5% by weight. The obtained developer was measured for the charge amount by a charge amount measurement device q/m-meter, made by Epping GmbH. The results are shown in Table 6.

Further for Examples 11 to 13 and Comparative Example 6, 47.5 g of the carrier alone was placed in a 50-cc glass bottle, stirred for 1 hour by a paint shaker, and thereafter mixed with a toner by the same method to fabricate a developer; and the developer was measured for the charge amount in the N/N environment, and a difference between this charge amount and the initial charge amount described above was indicated. The results are shown in Table 6.

TABLE 6

| | |
|---|---|
| Initial | After 1-hour |

| | | | | L/L charge | stirring | |
|---|---|---|---|---|---|---|
| | L/L | N/N | H/H | amount − | N/N | Initial - |
| | charge | charge | charge | H/H charge | charge | 1-hour |
| | amount | amount | amount | amount | amount | stirring |
| | (μC/g) | (μC/g) | (μC/g) | (μC/g) | (μC/g) | (μC/g) |
| Ex. 11 | −41.81 | −40.67 | −39.87 | 1.94 | −42.17 | 1.5 |
| Ex. 12 | −37.01 | −35.12 | −34.54 | 2.47 | −34.29 | 0.83 |
| Ex. 13 | −62.67 | −61.51 | −60.76 | 1.91 | −63.11 | 1.6 |
| Com. | −30.12 | −25.18 | −21.31 | 8.81 | −20.29 | 4.89 |
| Ex. 6 | | | | | | |

As is clear from the results of Table 6, Examples 11 to 13 each provided resin-coated carrier which had sufficient charge properties, and was sufficiently useful as a ferrite carrier for an electrophotographic developer. By contrast, although Comparative Example 6 carried out resin coating, the charge level and the environmental dependency of the charge amount were affected by the core material, and Comparative Example 6 had the result of being inferior to Example 12. Further, any of the obtained resin-coated carriers had sufficient charge properties even after stirred for 1 hour by a paint shaker, and was sufficiently useful as a ferrite carrier for an electrophotographic developer. By contrast, Comparative Example 6 exhibited a decrease in the charge amount due to peeling-off of the resin coating, and had the result of not being able to maintain the charge level.

The core material of a ferrite carrier for an electrophotographic developer according to the present invention has a high charge amount, and is excellent in the charge stability when it is made into an electrophotographic developer.

Therefore, the present invention can be broadly used particularly in the fields of full-color machines requiring a high image quality and high-speed machines requiring the reliability and durability of image maintenance.

1. A core material of a ferrite carrier for an electrophotographic developer, the core material comprising a ferrite particle comprising at least one or more temperature compensation-type dielectric components selected from Mg₂TiO₄, MgTiO₃ and MgTi₂O₄.

2. The core material of a ferrite carrier for an electrophotographic developer according to claim 1, wherein the total content of the temperature compensation-type dielectric components is 0.2 to 10% by weight

3. The core material of a ferrite carrier for an electrophotographic developer according to claim 1, wherein the contents of the temperature compensation-type dielectric components satisfy the relational expressions (1) and (2) described below:
The content of Mg₂TiO₄>the content of MgTiO₃; (1)
and
The content of Mg₂TiO₄>the content of MgTi₂O₄. (2)

4. The core material of a ferrite carrier for an electrophotographic developer according to claim 1, wherein the ferrite particle comprises Fe, Ti and Mg; and the contents thereof are 60 to 71% by weight of Fe, 0.5 to 5.5% by weight of Ti, and 0.5 to 3.5% by weight of Mg.

5. The core material of a ferrite carrier for an electrophotographic developer according to claim 1, wherein the core material has an oxide film formed on a surface thereof.

6. A ferrite carrier for an electrophotographic developer, wherein a core material of a ferrite carrier according to claim 1 has a surface coated with a resin.

7. An electrophotographic developer, comprising a ferrite carrier according to claim 6 and a toner.

8. The electrophotographic developer according to claim 7, wherein the electrophotographic developer is used as a refill developer.

9. A ferrite carrier for an electrophotographic developer, wherein a core material of a ferrite carrier according to claim 2 has a surface coated with a resin.

10. An electrophotographic developer, comprising a ferrite carrier according to claim 9 and a toner.

11. The electrophotographic developer according to claim 10, wherein the electrophotographic developer is used as a refill developer.

12. A ferrite carrier for an electrophotographic developer, wherein a core material of a ferrite carrier according to claim 3 has a surface coated with a resin.

13. An electrophotographic developer, comprising a ferrite carrier according to claim 12 and a toner.

14. The electrophotographic developer according to claim 13, wherein the electrophotographic developer is used as a refill developer.

15. A ferrite carrier for an electrophotographic developer, wherein a core material of a ferrite carrier according to claim 4 has a surface coated with a resin.

16. An electrophotographic developer, comprising a ferrite carrier according to claim 15 and a toner.

17. The electrophotographic developer according to claim 16, wherein the electrophotographic developer is used as a refill developer.

18. A ferrite carrier for an electrophotographic developer, wherein a core material of a ferrite carrier according to claim 5 has a surface coated with a resin.

19. An electrophotographic developer, comprising a ferrite carrier according to claim 18 and a toner.

20. The electrophotographic developer according to claim 19, wherein the electrophotographic developer is used as a refill developer.
